(19) United States
(12) Patent Application Publication
(10) Pub. No.: US 2012/0237656 A1
(43) Pub. Date: Sep. 20, 2012

(54) BAKING PANS

(76) Inventor: Louis HENRY, New York, NY (US)

(21) Appl. No.: 13/403,622

(22) Filed: Feb. 23, 2012

Related U.S. Application Data
(60) Provisional application No. 61/449,355, filed on Mar. 4, 2011.

(51) Int. Cl. B28B 7/24; A23P 1/10

(52) U.S. Cl. 426/512; 249/121

(57) ABSTRACT

Baking pans for use in food preparation comprise a top baking pan and a bottom baking pan each having complimentary cups formed therein, the complimentary cups defining cavities into which food preparation is placed and baked, chilled, solidified, etc. The cups of the top baking pan may be provided with apertures which allow gas to enter or leave the cavities.

### CROSS-REFERENCE TO RELATED APPLICATION

This application claims the benefit of U.S. Provisional Application No. 61/449,355, filed Mar. 4, 2011.

### TECHNICAL FIELD

This invention relates to pans used for shaping consumable food goods during their production. For example, the pans described herein may be configured to shape baked goods as they are baked or shape confectionary goods as they solidify from a pourable state.

### BACKGROUND OF THE INVENTION

Pans are a staple of any modern kitchen and are commonly used for baking, roasting, candy making, etc. While the traditional baking sheet, a flat, rectangular pan, is perhaps the most common pan used in the kitchen, more decorative pans have been proposed which are intended to impart a particular shape to the food being prepared therein. Examples of common decorative pans include bundt pans, Jello molds, cupcake pans and even ice cube trays.

However, such conventional decorative pans customarily have one open side into which the unformed food preparation is poured or placed. Thus, the side of the finished food item corresponding to the open side of the decorative pan is not contacted by the decorative pan during baking or solidification and is left relatively flat and plain. In order to obtain a finished good with no unshaped sides, therefore, it has traditionally been necessary to join two or more finished shaped goods together to reach the desired finished shape.

While molds used in other applications (such as thermoplastic injection molding, as one example) have been used to shape all finished surfaces of an item, particular obstacles exist in the food preparation context which prohibit the easy adaptation of such molds to the kitchen. For example, as a batter is baked in an oven, chemical and thermal processes within the batter typically cause it to rise, or expand in volume. Gasses or steam may be given off during this process. Similarly, when liquid confectionary preparations are solidified (for example, by a chilling step), the volume of such preparations may expand or contract by a substantial amount.

Such aspects have, until now, deterred the further development of baking pans. While some effort has been directed at elaborate food shaping machinery in the industrial food preparation industry, there exists an unmet demand for pans which are configured to shape all or substantially all finished surfaces of a consumable good and which are not so complex or expensive so as to prohibit their use in the home kitchen.

### BRIEF SUMMARY OF THE INVENTION

The present disclosure provides a baking pan assembly comprising a top pan, a bottom pan, and optional clips for holding the pans together. Each of the pans has cups therein. Food product is placed in the bottom pan cups for baking. When the top pan is placed over the bottom pan, a cavity is formed between the top cups and bottom cups. During baking, for example, the food product may rise to create a finished product that substantially conforms to the shape of the cavity. The top cups can have an aperture therein, to, for example, allow steam to escape during baking, allow the addition of additives, and/or prevent issues related to volume changes.

### BRIEF DESCRIPTION OF THE DRAWINGS

The above mentioned and other aspects, features and advantages can be more readily understood from the following detailed description with reference to the accompanying drawings wherein:

FIG. 1 shows a first perspective view of a baking pan according to one embodiment of the present invention with the top and bottom pans separated;

FIG. 2 shows a second perspective view of the baking pan assembly of FIG. 1 with the top and bottom pans assembled;

FIG. 3 shows a top view of a lower pan of a baking pan assembly according to one embodiment of the present invention;

FIG. 4 shows a side view of the lower pan of FIG. 3;

FIG. 5 shows a cross-sectional view of the lower pan of FIG. 4, along line A-A;

FIG. 6 shows a top view of a top pan of the baking pan assembly of FIG. 3;

FIG. 7 shows a side view of the top pan of FIG. 6;

FIG. 8 shows a cross-sectional view of the top pan of FIG. 7, along line B-B;

FIG. 9 shows sample food products that can be made with the baking pan assemblies according to embodiments of the present invention;

FIG. 10 shows an example of a cross-sectional partial view of the baking pan assembly of FIG. 2, along line C-C;

FIG. 11 shows another example of a cross-sectional partial view of a baking pan assembly according to one embodiment of the present invention similar to the view shown in FIG. 10;

FIG. 12 shows an example of a cross-sectional partial view of a baking pan assembly according to one embodiment of the present invention similar to the view along line D-D in FIG. 2; and

FIG. 13 shows another example of a cross-sectional partial view of a baking pan assembly according to one embodiment of the present invention similar to the view shown in FIG. 10.

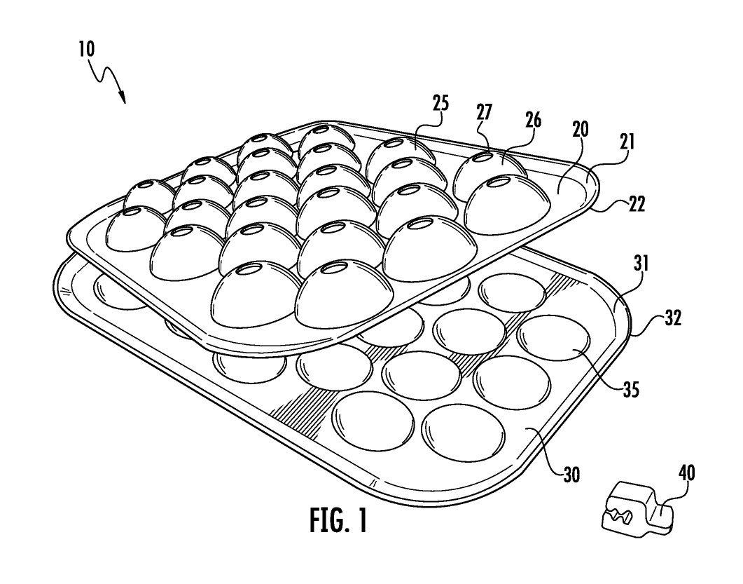

### DETAILED DESCRIPTION OF THE INVENTION

Referring to the drawings, baking pan assembly 10 is shown. Assembly 10 has top pan 20, bottom pan 30, and optional clips 40. Top pan 20 has a plurality of top cups 25, and bottom pan 30 has a plurality of bottom cups 35. Top cups 25 generally correspond in location to bottom cups 35, so that a cavity is formed between them when the top and bottom pans 20 and 30 are assembled. In the shown embodiment, top cups 25 and bottom cups 35 are spherical, but the present disclosure contemplates other shapes, such as but not limited to, oval, elliptical, square, rectangular, or other polygonal shapes. Top cups 25 can either have the same or different shapes as bottom cups 35. In one embodiment, top cups 25 and/or bottom cups 35 can be about one inch deep.

Top cups 25 can have apertures 27 in a top surface 26. Apertures 27 can also be located on other areas of cups 25, such as on the side. Apertures 27 may serve one or more purposes. For example, during baking, apertures 27 may allow steam to escape from cavities formed by top cups 25 and bottom cups 35, which allows for the food product within the cavities to rise. Apertures 27 may also allow a user to inject food product into the cavities or filling into or on the food product being cooked in the cavities, during, before or after baking.

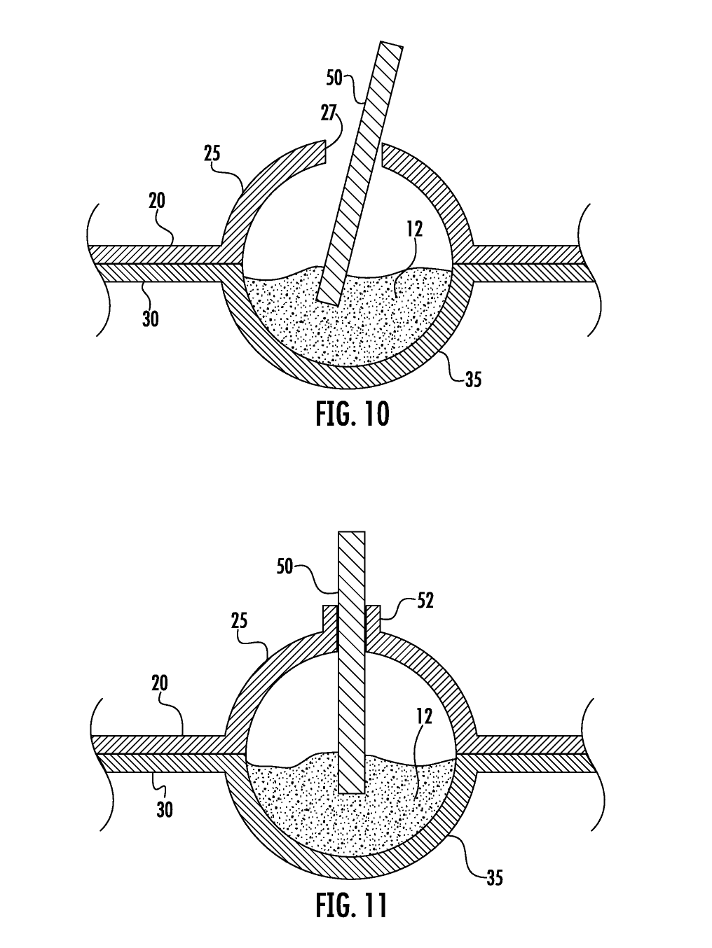

In another example, shown in FIG. 10, the apertures 27 may be configured to allow a holding stick 50 to be inserted into the cavity before, during or after food preparation 12 in the cavity is baked or solidified. The prepared food good may be removed from the baking pans together with holding stick 50 after lifting the top pan 30 from the bottom pan 20. In this example, the apertures 27 may be configured to align the holding sticks 50 in an upright position once inserted through the apertures 27. As shown in FIG. 11, apertures 27 may be configured with an extended barrel 52 or other feature to aid in aligning holding sticks 50.

In another example, the apertures 27 may be configured to allow inspection of the food preparation in the cavities. During baking, for example, a toothpick or other implement may be inserted through the apertures 27 to test if a batter has been baked to the point at which it no longer adheres to the toothpick upon removing the toothpick from the cavity.

As yet another example, when making candy or chocolate goods, apertures 27 may allow food preparation to be injected into the cavities and also may prevent an unwanted suction effect within the cavity if the food preparation should shrink in volume during a solidification step such as chilling.

Top pan 20 and bottom pan 30 can be made from materials suitable for baking, such as but not limited to aluminum, steel, or silicone. Either pan can also be coated with a non-stick coating.

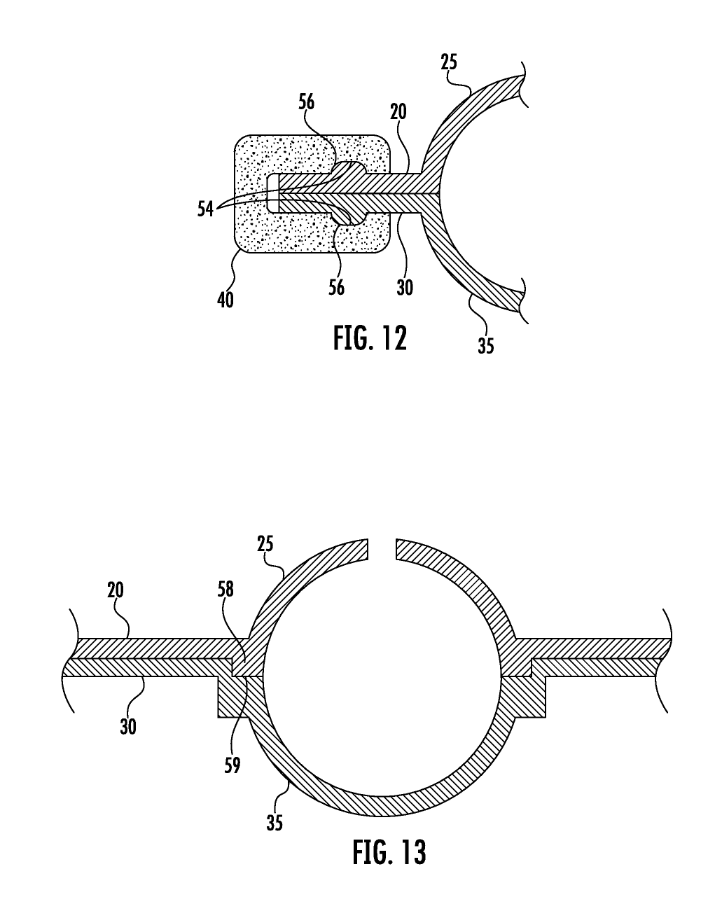

Once assembled, assembly pan 10 can be held together by clips 40, which can be made of silicone, or another suitable material that can withstand the heat of baking. Clips 40 are optional. The top and bottom pans 20 and 30 may also be provided with one or more clip retention features configured to aid the clips 40 in holding the baking pans together. For example, as shown in FIG. 12, the top and bottom pans 20 and 30 may each be provided with clip ridges 54 which are configured to engage with a complimentary channel 56 in the clips 40. Of course, many other clip retention feature configurations are possible.

Top pan 20 can simply rest on top of bottom pan 30, or the two can be aligned, held or connected together with methods such as a snap fit, pressure fit, tongue and groove, etc. Top pan 20 and bottom pan 30 can have top lip 22 and bottom lip 32 respectively, around outer edges of the pans, to facilitate connection with clip 40, or the other connection methods discussed. Top pan 20 and bottom pan 30 can also have tapered portions 21 and 31 respectively near the outer edges, which can mate with each other to help assembly 10 stay secure during use. In another example, the top cups 25 and bottom cups 35 may be provided with complimentary features to aid in alignment of the top and bottom trays 20 and 30 to one another. For example, as shown in FIG. 13, top cups 25 may be provided with a protruded rim 58 while bottom cups 35 may be provided with a corresponding recessed rim 59 or vice versa.

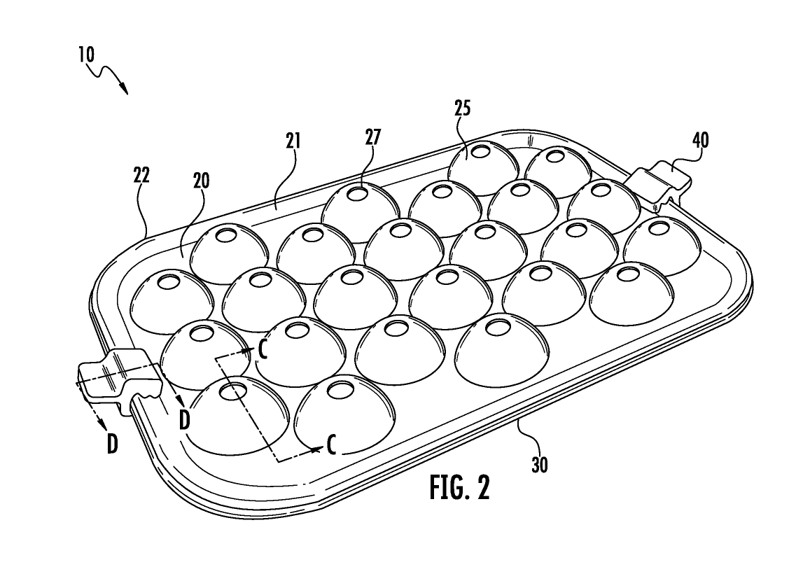

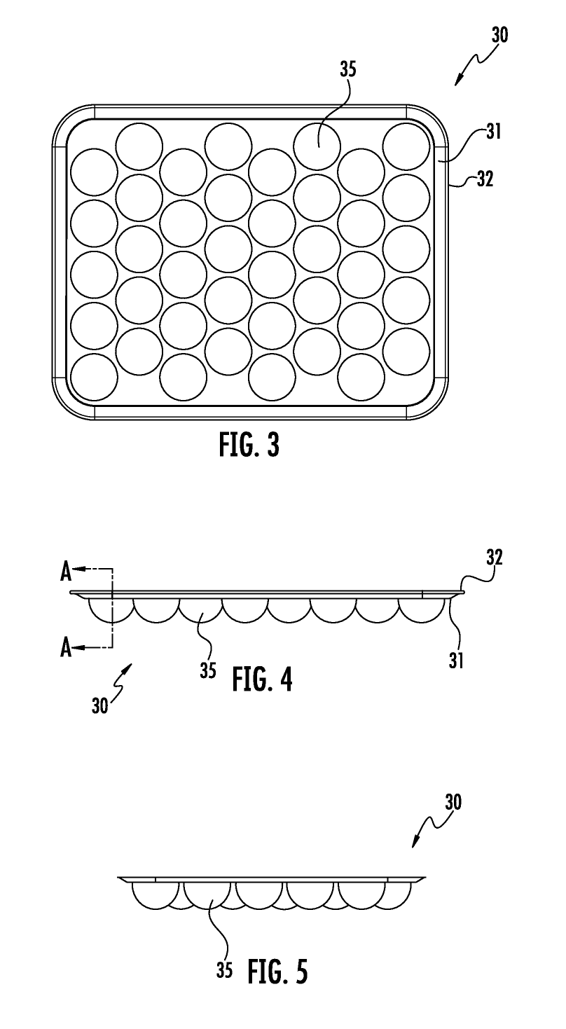

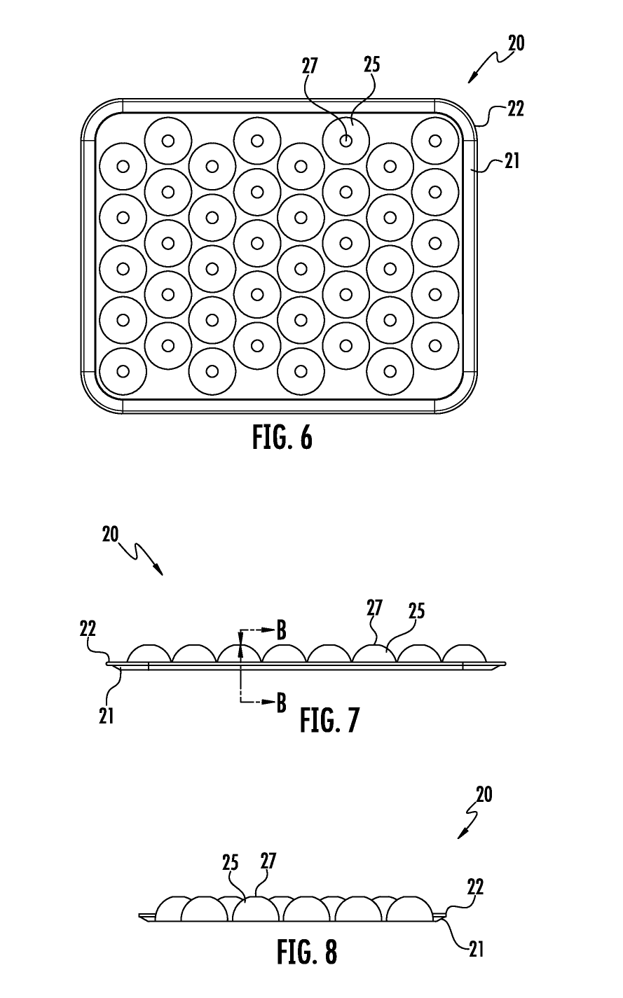

To use, the top pan 20 may be placed over bottom pan 30 (as shown in FIG. 2) and batter or other food preparations can be placed in bottom cups 35 and/or top cups 25, either before or after the top pan 20 is placed over the bottom pan 30. Optionally, the top and bottom pans 20 and 30 may be held together by clips 40. When used as a baking pan, the entire baking pan assembly 10 may be placed in a baking apparatus such as an oven once filled and assembled. When used as a candy or chocolate pan, the entire baking pan assembly 10 may be placed in a chilling apparatus such as a refrigerator or freezer once filled and assembled.

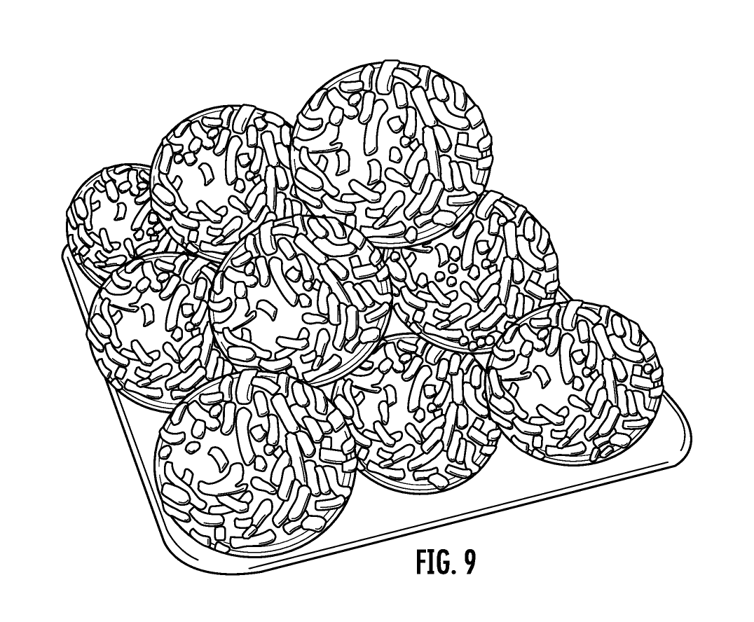

FIG. 9 shows sample food products that can be made with assembly 10. The food products can be made in a variety of shapes, such as spherical, and can have additives such as fillings, or surface additives such as sprinkles or flaked flavorings. The food products made with assembly 10 are advantageous in that they are easily made into a variety of shapes, but are baked instead of fried. Assembly 10 also provides for easier use, assembly, and cleaning than other devices that fry the food products, and does not require large amounts of cooking oil, which can be wasteful and expensive.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure. In addition, elements and/or features of different illustrative and exemplary embodiments herein may be combined with each other and/or substituted for each other within the scope of this disclosure.

What is claimed is:

1. A baking pan assembly comprising:
a first baking pan including at least one cup; and
a second baking pan including at least one cup, wherein the at least one cup of the first baking pan and the at least one cup of the second baking pan are arranged adjacent to one another and together define a cavity when the first and second baking pans are in an assembled position; and
the at least one cup of the second baking pan includes an aperture.

2. The baking pan assembly of claim 1, wherein the cavity is generally spherical.

3. The baking pan assembly of claim 1, wherein the first and second baking pans seal to one another in the assembled position and the aperture is configured to permit gas to escape the cavity.

4. The baking pan assembly of claim 1, wherein the at least one cup of the first baking pan does not include an aperture.

5. The baking pan assembly of claim 1, further comprising at least one clip configured to hold the first baking pan and the second baking pan together in the assembled position.

6. The baking pan assembly of claim 5, wherein at least one of the first and second baking pan includes a clip retention feature configured to assist the at least one clip in holding the first baking pan and second baking pan together in the assembled position.

7. The baking pan assembly of claim 1, wherein the first baking pan and the second baking pan each include an alignment feature, the alignment feature of the first baking pan being configured to engage the alignment feature of the second baking pan to align the first baking pan to the second baking pan in the assembled position.

8. The baking pan assembly of claim 7, wherein the alignment feature of one of the first and second baking pans is a raised ridge at a rim of at least one cup and the alignment feature of the other of the first and second baking pans is a recession at a rim of an adjacent at least one cup.

9. A method of baking a shaped food article, the method comprising the steps of:
(a) placing unbaked food preparation into at least one cup of a first baking pan;
(b) assembling a second baking pan having at least one cup corresponding to the at least one cup of the first baking pan over the first baking pan such that the at least one cup of the first baking pan is adjacent to the at least one cup of the second baking pan;
(c) providing an aperture in the at least one cup of the second baking pan;
(d) placing the assembled first and second baking pans containing the food preparation into an oven; and
(e) allowing the food preparation to bake within a cavity formed by the at least one cup of the first baking pan and the adjacent at least one cup of the second baking pan.

10. The method of claim 9, further comprising the step of:
(f) allowing gas to escape the cavity through the aperture during the baking step (e).
